(19) United States
(12) Patent Application Publication
(10) Pub. No.: US 2005/0035577 A1
(43) Pub. Date: Feb. 17, 2005

(54) Vehicle occupant restraint system

(75) Inventors: Thomas Barko, Stockstadt (DE); Joachim Fellhauer, Nilkheim (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/917,001

(22) Filed: Aug. 12, 2004

(30) Foreign Application Priority Data
Aug. 14, 2003 (DE) 203 12 596.7

(51) Int. Cl. B60R 21/22

(52) U.S. Cl. 280/730.2

(57) ABSTRACT

A vehicle occupant restraint system comprises a front gas bag, a side gas bag separate therefrom, which in the inflated state extends up to the inflated front gas bag, and a control unit for activating the gas bags. The control unit is programmed so that it activates both gas bags with at least one of a frontal impact, a laterally displaced frontal impact and with an impact from obliquely front.

### TECHNICAL FIELD

The invention relates to a vehicle occupant restraint system with several inflatable gas bags.

### BACKGROUND OF THE INVENTION

Occupant restraint systems with gas bags today offer a high potential for protection both in a frontal impact and also in a side impact. Frontal gas bags are gas bags arranged in front of the occupant (for example in the steering wheel or in the instrument panel in front of the front seat passenger), which are activated in a frontal impact and into which the occupant plunges. In addition, there are side gas bags which extend for example to the side of the thorax of the occupant or to the side of the head of the occupant and which are activated in a side impact.

### BRIEF SUMMARY OF THE INVENTION

The invention provides an occupant restraint system which develops an improved protective effect in an impact, which is not a purely front and not a purely side impact, but rather in a laterally displaced frontal impact, which provides for a torque of the vehicle, and/or in an impact from obliquely front.

The occupant restraint system according to the invention comprises a front gas bag, a side gas bag separate therefrom, which in the inflated state extends up to the inflated front gas bag, and a control unit for activating the gas bags, i.e. for activating the corresponding inflation systems. The control unit is programmed so that it activates both gas bags in a frontal impact, a laterally displaced impact and/or an impact from obliquely front.

Preferably the control unit is programmed so that with a laterally displaced frontal impact and an impact from obliquely front, it activates both gas bags.

The side gas bag, which is separate from the front gas bag and forms a separate unit, serves as guide cushion for the occupant in a laterally displaced impact or an impact from obliquely front. The occupant strikes onto the side gas bag and is prevented by the latter from a contact with hard vehicle parts and is directed to the front gas bag, by which he is principally restrained. The main function of the side gas bag is therefore a directing function; the restraining function is principally carried out by the front gas bag.

The inflated side gas bag does not serve for protection in a purely side impact; other additional side gas bags can be provided for this. The inflated side gas bag therefore begins to the front and side of an associated 50% occupant, in order to extend forward toward the front occupant. The 50% occupant is symbolized by an internationally standardized 50% dummy (Hybrid III-Dummy), with which restraint systems are usually tested.

The inflated side gas bag preferably only has a longitudinal extent of 400 to 1000 mm, preferably 400 to 700 mm, in the longitudinal direction of the vehicle.

The inflated side gas bag is to begin at least approximately 400 mm in front of the associated backrest, in order to extend in longitudinal direction of the vehicle forward toward the front gas bag. Thereby, it is to be ruled out that the side gas bag, which serves as guide gas bag, can collide with protective systems which are to be activated in a side impact, which lie immediately to the side of the occupant (e.g. a thorax gas bag).

The side gas bag provided for guidance is to be housed underneath the window in the door of the vehicle or in the side wall (if no door is provided to the side of the occupant who is to be protected).

The inflated side gas bag extends downwards from the window sill; preferably it has a height of 300 to 550 mm, to keep its volume small.

The fully inflated side gas bag has a maximum internal pressure (measured without the influence of the occupant), which is greater, preferably greater by at least the factor 2, than that of the fully inflated front gas bag. This serves to optimize the main objectives of the individual gas bags. The side gas bag is to have a guiding function and is therefore extremely hard, whereas the front gas bag, in addition to the restraining function, is also to undertake a damping function as much as possible, and is therefore designed so as to be softer.

So that in an impact from obliquely front, the occupant can not arrive between the two inflated gas bags, provision is made that the side gas bag and the front gas bag in the inflated state, viewed transversely to the vehicle longitudinal direction, intersect each other and have overlap sections adjoining each other. These overlap sections lie in the front marginal region of the side gas bag lying on the inner side, against which the front gas bag can lie.

As already mentioned, the occupant restraint system according to the invention can also be equipped with additional, purely side gas bags. These lie in the inflated state immediately to the side of the occupant and are separated from the previously mentioned side gas bag, serving for guidance. These gas bags are activated by the control unit in the case of a purely side impact.

A further advantage of the restraint system according to the invention also lies in that in an oblique impact, for example the curtain—or window bags, which have a large area, do not have to be inflated, the reinstallation of which is substantially more expensive than a gas bag housed in the door lining, serving for guidance. Furthermore, the displaced air volume in the vehicle interior is less than in a system in which already in a laterally displaced frontal impact, front gas bags and, at the same time, purely side gas bags having a large volume, are inflated. In vehicles in which no purely side gas bags having a large area are provided (e.g. cabrios, roadsters), the invention provides an improvement to the protection on displaced impact and on oblique impact.

Further features and advantages of the invention will be apparent from the following description and from the following drawings, to which reference is made.

### BRIEF DESCRIPTIONS OF THE DRAWINGS

FIG. 1 shows a diagrammatic side view of the vehicle occupant restraint system according to the invention, and

FIG. 2 shows a top view onto the restraint system according to the invention in accordance with FIG. 1.

### DETAILED DESCRIPTION OF THE PREFERRED EMBODIMENT

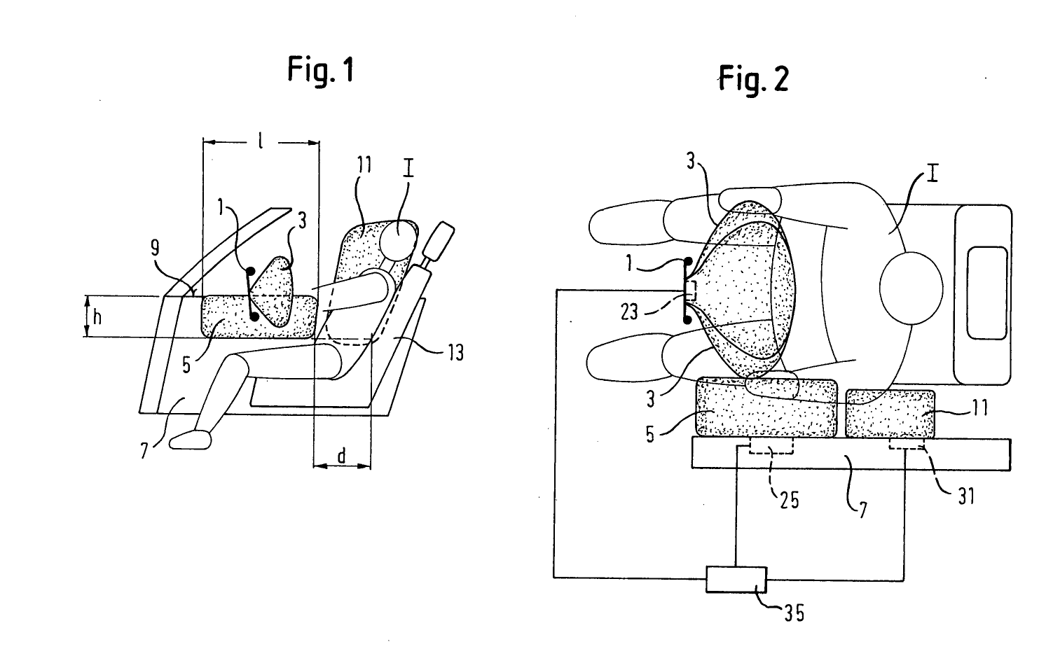

In FIG. 1 a vehicle occupant restraint system is illustrated for an average occupant I. The occupant I, as illustrated, is an occupant of average size and weight, who is symbolized by a 50% dummy.

The restraint system has a front gas bag 3 housed in the steering wheel 1, which depending on the vehicle, as can be seen in FIG. 2, may have different lateral extents. The occupant restraint system has in addition a side gas bag 5, separate from the front gas bag 3, which has an elongated, cushion-shaped form, is housed in the door 7 beneath the window sill 9 and hidden underneath the door lining, and in the inflated state extends downwards from the region of the window sill 9 over a height h of 300 to 550 mm. The inflated side gas bag 5 has a longitudinal extent 1 of 400 to 1000 mm, preferably between 400 and 700 mm, measured in longitudinal direction of the vehicle. The side gas bag 5 begins in front of the occupant I, therefore does not lie immediately to the side of the thorax region of the occupant I (on whose height it lies), but rather in front. The gas bag 5 extends up to the front gas bag 3, laterally along it to close to the front door end. In side view according to FIG. 2, the gas bags 3 and 5 overlap each other; it can also be seen in FIG. 2 that with a front gas bag 3 having a large volume, the latter can lie with its lateral edge against the side gas bag 5.

The restraint system according to the invention can even have a third gas bag 11, which is a purely side gas bag and extends immediately to the side of the upper body and head of the occupant I towards the side. This side gas bag 11 can be housed in the vehicle door 7, in the backrest 13 or else in the roof frame (not shown). The side gas bag 11 lies in longitudinal direction of the vehicle preferably completely behind the side gas bag 5.

The beginning of the side gas bag 5, viewed by the occupant I, can also be defined in that it lies at least approximately 400 mm in front of the associated backrest 13. This length d is measured in horizontal direction and is the smallest distance of the section of the back rest 13 which lies at the height of the side gas bag 5.

Each gas bag 3, 5, 11 has its own gas generator 23, 25, 31 associated with it, which are all coupled with an electronic control unit 35. The control unit 35 in turn is coupled with several sensors which are not shown, which can determine the impact intensity and the direction of the introduction of the force into the vehicle. According to an embodiment, the two gas bags 3 and 5 are activated in every case when a frontal impact takes place without displacement, a laterally displaced frontal impact or an impact from obliquely front. According to another option, with another sensor arrangement the control unit 35 makes provision that in a frontal impact with complete overlap (i.e. no displacement), only the front gas bag 3 is activated and inflated. If it is possibly also determined that the position of the occupant is not correct, the side gas bag 4 is also activated in such an impact. In a laterally displaced frontal impact or an impact from obliquely front, both gas bags 3, 5 are inflated.

In the fully inflated state of both gas bags 3, 5, the side gas bag 5 has an internal pressure greater by at least the factor 2 than the front gas bag 3.

In an impact from obliquely front, the side gas bag 5 prevents the occupant I from being restrained at the edge of the gas bag 3; the side gas bag 5 guides him as it were with the displacement forward centrally to the front gas bag 3, where he is restrained. Furthermore, the side gas bag 5 prevents contact with parts in the interior.

The front gas bag 1 can of course also be constructed as a front gas bag for a front seat passenger or rear occupant.

1. A vehicle occupant restraint system, comprising
a front gas bag (3),
a side gas bag (5) separate therefrom, which in the inflated state extends up to said inflated front gas bag (3),
a control unit (35) for activating said gas bags (3, 5),
the control unit (35) being programmed so that it activates both gas bags (3, 5) with at least one of a frontal impact, a laterally displaced frontal impact and with an impact from obliquely front.

2. The vehicle occupant restraint system according to claim 1, wherein said control unit (35) is programmed so that with a laterally displaced frontal impact and with an impact from obliquely front, it activates both gas bags (3, 5).

3. The vehicle occupant restraint system according to claim 1, wherein said inflated side gas bag (5) begins at a front and to a side of an associated 50% occupant and extends forward.

4. The vehicle occupant restraint system according to claim 1, wherein said inflated side gas bag (5) has a longitudinal extent of 400 to 1000 mm in longitudinal direction of a vehicle in which said restraint system is mounted.

5. The vehicle occupant restraint system according to claim 1, wherein said inflated side gas bag (5) begins at least approximately 400 mm in front of an associated backrest (13), in order to extend forward in longitudinal direction of a vehicle in which said restraint system is mounted.

6. The vehicle occupant restraint system according to claim 1, wherein said side gas bag (5) is housed underneath a window in one of a side wall and a door (7) of a vehicle in which said restraint system is mounted.

7. The vehicle occupant restraint system according to claim 1, wherein said inflated side gas bag (5) extends downwards from a window sill (9).

8. The vehicle occupant restraint system according to claim 1, wherein said inflated side gas bag (5) has a height (h) of 300 to 550 mm.

9. The vehicle occupant restraint system according to claim 1, wherein said side gas bag (5) in its fully inflated state has a maximum internal pressure which is greater than that of said fully inflated front gas bag (3).

10. The vehicle occupant restraint system according to claim 9, wherein said internal pressure of said side gas bag (5) in its fully inflated state is greater than that of said front gas bag (3) at least by the factor 2.

11. The vehicle occupant restraint system according to claim 1, wherein said inflated side gas bag (5) and said inflated front gas bag (3), viewed transversely to a longitudinal direction of a vehicle in which said restraint system is mounted, intersect each other and have overlap sections adjoining each other.

12. The vehicle occupant restraint system according to claim 1, wherein an additional, second side gas bag (11) is provided, which in its inflated state is arranged immediately to a side of an associated occupant (I) and is separate from said first side gas bag (5).

13. The vehicle occupant restraint system according to claim 12, wherein said control unit (35) is constructed so that it activates said additional, second side gas bag (11) in a side impact.

14. A vehicle occupant restraint system with a front gas bag (3) and a side gas bag (5) separate therefrom, which begins in front of an occupant and extends along a vehicle door (5) to at least beside said front gas bag (3).
